(19) United States
(12) Patent Application Publication
(10) Pub. No.: US 2007/0299776 A1
(43) Pub. Date: Dec. 27, 2007

(54) Method for preventing medical fraud

(76) Inventors: Michael Vincent Frustaci, Sutton, MA (US); Frederick Romolo Giovanelli, Manhasset, NY (US)

Correspondence Address: MICHAEL V. FRUSTACI, 24 WELSH ROAD, SUTTON, MA, 01590, US

(21) Appl. No.: 11/233,413

(22) Filed: Dec. 6, 2005

(51) Int. Cl. G06Q 10/00; G01S 5/02

(52) U.S. Cl. 705/50; 340/539.13; 705/1; 705/39

(57) ABSTRACT

The use of a real time transmitted encrypted identification system to verify patient ID, location, time and medical service provider identification helps to prevent fraudulent insurance claims. The system may use a networked laptop computer having identity capturing systems such as a bar code reader, magnetic card reader, smartcard reader, RF transponder, fingerprint capture, signature capture, photo image capture or facial recognition software for the patient, the medical service provider, and may have a GPS system, or other location system, to ensure that the ID capture occurs at the authorized location. Insurance companies may provide their authorized medical providers with the networked laptop, or other ID capture device, and control the verification system within the single company, or may be customers of a verification center that handles all or some of the insurance payors in an area.

### TECHNICAL FIELD

This application relates generally to reducing medical insurance fraud and, more particularly, to providing a method proving that patients are present at claimed medical treatments.

### BACKGROUND

The medical insurance industry has a market driven need to reduce the number of fraudulent claims. Other areas of the medical field have long ordered and regulated their processes to reduce errors and criminal activity. For example, having a prescription filled at any pharmacy is now a carefully regulated process that may use substantial computerization on both the medical doctor's (MD) part and on the part of the pharmacy. The patient presents the doctor's written prescription (Rx) to the pharmacist, or the Rx is telephoned or Emailed to the pharmacist to reduce error rates. The Rx may be processed by creating a computer file and an automated label for the drug container. The computer file may have the relevant insurance information to determine the co-payment, if any, that is due immediately upon receiving the Rx, and which may depend upon the classification of the particular generic or brand name drug prescribed. The computer may also automatically submit a claim to a third party payer, such as a medical insurance company, and check the patient record for potential drug interactions of the Rx with other medicines that the patient is known to be taking.

The final step in the prescription process may be the pharmacist checking the accuracy of both the label and drug in the container, and having the patient sign an insurance pick up portion of the label containing a prescription number that specifically identifies the Rx. The signature of the patient may then be pasted into a log book to provide proof that the pharmacy has dispensed the prescribed drug, and is legally available to third parties such as insurance companies as evidence of actual performance of service.

In the case that the prescription is not picked up by the patient, there is no signature in the log book, and after a period of time the “orphaned” prescription is returned to the stock inventory, and the computer insurance claim is cancelled or reversed so that there is no payment for services not delivered.

It is known that certain medical operations provide medical, chiropractic, or other services to fraudulent “patients” who never receive the supposed treatments that are charged to the insurance companies. Some of these “patients” never even visit the medical offices, or drive by in the morning on the way to work, sign in and leave without receiving the claimed treatment. Some of these “patients” receive payment of part of the insurance costs for their participation in these fraudulent practices, which are alleged to cost the insurance companies, and thus indirectly the population in general in the form of increased insurance rates, over $100 billion a year.

A similar situation is known to exist in the welfare environment, where individuals have been found to fraudulently hide income, apply for assistance in multiple states, apply for assistance under multiple identities, and claim assistance for non-existent dependents. False identification cards, such as drivers licenses and other written forms of identification, are available, and even where proper identification is provided, the authorities do not possess sufficient resources to cross check in other jurisdictions to prevent fraud, especially in the absence of a simple inexpensive computerized checking system. The same system may also be used to provide information on prescription drugs prescribed by the same or different medical service providers using the system, to help prevent negative drug interactions, drug abuse and multiple prescriptions from different providers.

Thus there exists a need in the art for a simple, fast and accurate method for verification of identity of a service user, such as a patient or a welfare applicant, verification of the location and time of the delivery of the service, such as at a doctors office, verification of the authorization of the user to receive the service, and some level of confidence that the service was provided. As an example, a patient may arrive at a doctors office, sign in or punch a time clock, and leave, and no one at the insurance company would be able to show that the claimed service was not provided, if the doctor's office staff was involved in the fraud.

### SUMMARY

The abovementioned issues are addressed by the present invention and will be understood by reading and studying the following specification.

A method of verifing provision of services to an authorized service user is disclosed, including assigning a unique identifying number to each one of a group of authorized service providers, such as doctors. Also assigning a unique identifying number to each one of a group of authorized service users, for example insured patients. The method determines how likely an insurance claim by a service provider is to be a valid claim by defining at least one unique identifying feature of each one of the authorized patients and for each one of the authorized doctors. The method looks at certain defined factors of the service, such as the patient beginning time at the provider location, and the patient completion time (resulting in an elapsed service time period). The patient physical location may be determined, for example by an attached GPS system at the provider location, patient and providers fingerprints may be captured, eye scan profiles, signature captures, facial recognition scans, PIN numbers, smart card or magnetic card reading, biometric data captures for both patient and provider may be obtained, and transmitted to a service confirmation center in real time, to help verify the validity of the insurance claim. The verification data may then be provided to a group of payors, typically insurance companies, who would have an improved certainty of only paying valid claims. The method may also be used in non medical situations as discussed above, with changes in the details that one of ordinary skill in the art will easily understand.

The method may include classifying a level of certainty of valid service provision into two or more levels in response to the total number of identifying and validating features provided, such as the time of day being reasonable, the length of time the patient spent at the physical location being reasonable for the specific treatment provided, but not such a long time that the patient had time to leave and return (i.e., a “drive by” check in). The classification may include a weighting factor assigned to each of the measured items depending upon it's value in proving proper service provision, and the level of certainty may be determined by a numerical value obtained by summing the weighting factors of each one the identifying features. Then the service confirmation center may provide the verification data and/or numerical values to the appropriate one of the group of payors, typically insurance companies, based on data indicating a contract between the insurer and the patient or doctor.

The method may further include data on whether the specific service provided is authorized for the particular patient, or whether the doctor is authorized to provide the particular treatment provided, and whether or not the elapsed time at the doctor is within a proper time range for the specific service provided, or whether the time of day is reasonable. The transmitted information may be encrypted and neither the provider nor patient may have access to the encrypted data, and each transmission device may broadcast a unique identification code, as well as a GPS location signal.

Payment for the service center may be from the insurance company receiving the verification data in response to the number of service verifications provided, or as a monthly service charge irrespective of the number of verifications provided, or as a percentage of reduced fraudulent claims, or from the physicians in response to the reduced payment times for claims.

The verification data may be provided to the insurers as a numerical value, such as 1-100, or as a letter evaluation, such as A, B, C, D or F, or as a written code, such as “requires additional investigation”. In an embodiment, each identifying feature has a value, such as fingerprint identification having a value of 10, signature capture a value of 8, facial recognition capture a value of 6, eye scan profile a value of 4, elapsed time at service provider being within a preselected range for the indicated service provided a value of 1, and time of service being within a preselected range a value of 1, resulting in a maximum possible verification value of 30 in this illustrative embodiment. Alterations and reductions may be included, for example with a time of service being outside a reasonable range, or an elapsed time at service provider being outside a reasonable range, having a value of negative 16. A cumulative value of the identifying features being greater than 24 might be graded as an assured good claim not needing any further investigation and thus eligible for immediate payment of the claim. This may be a motivating factor in obtaining service provider agreement to use the method. A claim with a cumulative value of less than 25 but greater than 14 may indicate a highly probable valid claim, but one that should be subject to random sampling for further investigation. A claim with a cumulative value of less than 15 may require further evaluation before payment is approved.

The method may be implemented by having the service center provide a device to obtain and transmit the encrypted data by radio, WiFi network, Internet connection, telephone or cable, in real time, to the service confirmation center. The device may be a personal computer or laptop, where the integrity of the data capture is further assured by a GPS system physically attached to, or incorporated inside, the device. The device may disable transmissions in response to an unauthorized data manipulation and/or an unauthorized access attempt, and may attempt to transmit a system down code to the service center, or set a danger flag within the system, and cease operating until restarted by a coded signal from the service center. Other security methods may also be used including physical security methods such as locks.

The method provides an insurer verification of patient identification and service provider identification via an encrypted secure system that measures and evaluates features such as fingerprints, eye scan, facial recognition, biometric data, signature, voice print, physical location of the encrypted system (and thus the patient and doctor) and time of service commencement and time of service completion. These measurements may be made by attached equipment, or incorporated within the main unit of the device. This helps prevent fraudulent or erroneous insurance claims.

These and other aspects, embodiments, advantages, and features will become apparent from the following description and the referenced drawings.

### BRIEF DESCRIPTION OF THE DRAWINGS

FIG. 1, illustrates an embodiment of a system to capture identification data in a secure system and transfer it to a payor entity.

### DETAILED DESCRIPTION

The following detailed description refers to the accompanying drawing that shows, by way of illustration, specific aspects and embodiments in which the present invention may be practiced. These embodiments are described in sufficient detail to enable those skilled in the art to practice the present invention. Other embodiments may be utilized and structural, logical, and electrical changes may be made without departing from the scope of the present invention. The various embodiments are not necessarily mutually exclusive, as some embodiments and features can be combined with one or more other embodiments and features to form new embodiments.

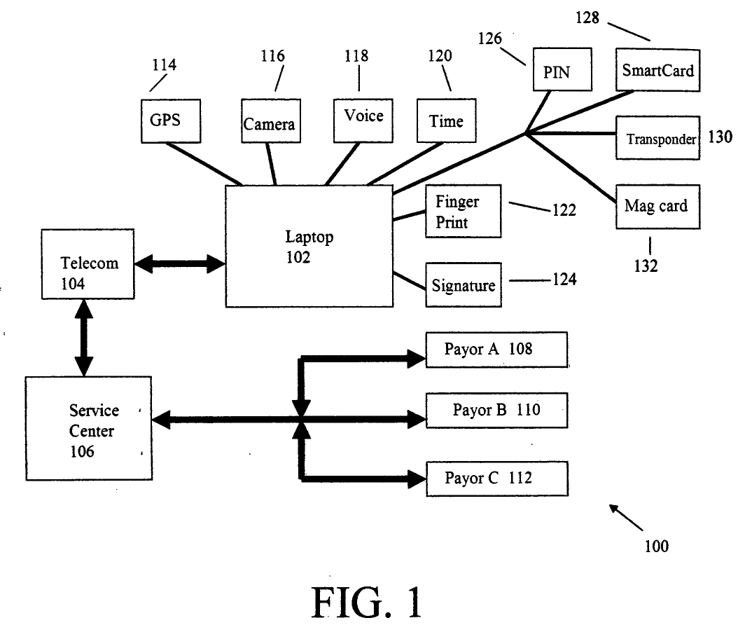

FIG. 1 shows an embodiment of an illustrative system 100 to provide at least one payor organization sufficient information on the identity, location and time of a claimed delivery of a service, to be able to classify the claim as worthy of immediate payment, or requiring various levels of further investigation to prevent fraudulent claims.

Illustrative system 100 comprises a laptop computer 102, having a unidirectional or bidirectional connection to some form of communication device 104, which may be external or internal to the laptop computer 102. This illustrative embodiment discloses a laptop computer, but the invention is not so limited, and may employ a dedicated custom electronic device in place of the general purpose computer shown, or may use a personal computer, a server, or any other form of calculating device. The communication device may be a telecommunication device such as a telephone, cellular phone, PCS, internet connection, AM radio, FM radio, citizen's band radio, Ham radio, cable connection, WiFi network or other communication device, as would be clear to one of ordinary skill in the art.

The telecom device 104 will have either a unidirectional or bidirectional connection to either a dedicated service center 106, or directly to an insurance company, or some other location for processing of the information. Typically, a service center 106 will have a contract with a number of claim payor organizations, such as insurance companies, reinsurance companies or insurance groups, such as the illustrated payors 108, 110 and 112, and will have either a unidirectional or bidirectional communications connection to the payors.

The illustrative laptop 102 may have physical, software and electronic security and counter intrusion devices built into the laptop, such as key locks on the data storage devices, software firewalls, and anti-intrusion lock-out programs and transmitted alerts. The laptop may also have any or all of a series of identity capturing systems, such as a global positioning system (GPS) 114 to identify and transmit the location of the laptop 102 (and thus the location of the patient and doctor), a camera or imaging system 116 for facial identification and biometric capture for either or both of the patient and doctor, a voice recognition system 118, a time of day and elapsed time between log in and log out system 120, to provide protection from after hours fraudulent logins and to raise a flag at the service center or payor location, a finger print capture system 122 and a signature identification system 124, personal identification number (PIN) capture unit 126, a smart card reader 128, a transponder reader 130, and a magnetic card reader 132. Any or all of these data capture systems may attached to the laptop, or incorporated securely within the laptop. All of these identification systems may be used on both the patient and the doctor to indicate that both parties were in the same GPS identified location at the same time, and that the time between patient check in and check out is long enough to have provided the patient with proper time to have the doctor perform the indicated service. If the elapsed time is too long, it may raise a flag that a drive by check in has occurred, with the fraudulent patient checking in during the morning, perhaps while driving to work.

The various identifying features captured by the system 100 may have various values in terms of verification of proper provision of services. A finger print system may be fooled by a fingerprint overlap, and perhaps finger prints should not be accorded as much weight as a camera 116 eye scan in certain circumstances. Various different situations, such as the multiple welfare applications scenario, may not give as much value to identifying features such as the GPS, since the location of an office in that situation is clearer than in the case of medical insurance fraud, where the doctor is often not present at all.

The service center 106 may be supported as an independent contractor receiving payment from individual insurance companies in return for the reduced cost associated with having to perform claim validity checks by hand. The individual insurance companies might pay by the number of claim validations, or may pay a flat monthly access fee. The insurance companies may work individually or in cooperation with each other.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations of embodiments of the present invention, including but not limited to its application in non-medical insurance cases such as disaster relief, non-medical situations such as distribution of welfare payments, and in other governmental situations. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present invention includes any other applications in which embodiments of the above structures and fabrication methods are used. The scope of the embodiments of the present invention should be determined with reference to the appended claims, along with the full scope of equivalents to which such claims are entitled.

What is claimed is:

1. A method of verifying provision of services to an authorized service user, comprising:
assigning a unique identifying number to each individual one of a plurality of authorized service providers;
assigning a unique identifying number to each individual one of a plurality of authorized service users;
determining at least one unique identifying feature of each individual one of the plurality of authorized service users and each individual one of the plurality of authorized service providers;
providing at least one of an authorized service user beginning time at service provider, an authorized service user completion time at authorized service provider, authorized service user physical location at authorized service provider, authorized service user fingerprint at authorized service provider, authorized service user eye scan profile at authorized service provider, authorized service user signature capture at authorized service provider, and authorized service user facial recognition scan at authorized service provider to a service confirmation center in real time;
providing at least one of an authorized service provider fingerprint, authorized service provider eye scan, authorized service provider signature capture, authorized service provider facial recognition scan, a code identifying the specific service provided, and authorized service provider time of service to the service confirmation center in real time to verify the provision of services to the authorized service user; and
transmitting the verification of services provided to the authorized service user by the authorized service provider to at least one of a plurality of payors.

2. The method of claim 1, wherein the verification of services further includes classifying a level of certainty of proper service provision into two or more levels in response to the number of identifying features provided.

3. The method of claim 2, wherein each of the at least one unique identifying feature of each authorized service user and each authorized service provider has a weighting factor assigned, and the level of certainty is determined by a numerical value obtained by summing the weighting factors of each one of the at least one unique identifying features of the authorized service users transmitted to the service confirmation center in real time.

4. The method of claim 1, wherein the service confirmation center provides the verification of services transmission to a selected one of the plurality of payors in response to data indicating a contract between the selected one payor and the individual one of the plurality of authorized service users and between the selected payor and the individual one of the plurality of authorized service providers.

5. The method of claim 4, wherein the verification of services transmission further includes data on whether the specific service provided is authorized for the user, for the provider, and whether or not an elapsed time between the beginning time at service provider and the user completion time at service provider is within a pre-selected and stored maximum and minimum time range for the specific service provided.

6. The method of claim 1, further providing each individual one of the plurality of authorized service users with an encrypted data record containing at least one of a user name, a unique identification number, a contracted service payor identification number, and a contracted service provider identification.

7. The method of claim 1, further providing each individual one of the plurality of authorized service providers with an encrypted data capture and transmission device connected in real time to the service confirmation center, for transmitting at least a user identification feature and time at the service provider, and a physical location and unique identification of the data capture and transmission device.

8. The method of claim 7, wherein the authorized service provider does not have access to the encrypted data and each transmission device broadcasts a unique identification code.

9. The method of claim 1, wherein the service confirmation center receives a payment from the plurality of payors in response to the number of verification of services provided to the authorized user having contracts with the payors.

10. The method of claim 1, wherein the service confirmation center receives payment from individual ones of the plurality of payors in response to the number of verifications provided to the individual one payor.

11. The method of claim 3, wherein fingerprint capture has an assigned value of 10, signature capture has an assigned value of 8, facial recognition capture has an assigned value of 6, eye scan profile has an assigned value of 4, elapsed time at service provider being within a preselected range for the indicated service provided has an assigned value of 1, time of service being within a preselected range has an assigned value of 1, time of service being outside the preselected range has an assigned value of negative 16, and elapsed time at service provider being outside the preselected range has a value of negative 16.

12. The method of claim 11, wherein a cumulative value of the assigned values greater than 24 is graded as assured, a cumulative value of less than 25 but greater than 14 is graded as sample evaluate, a cumulative value of less than 15 is graded as requires further evaluation, and at least one of the cumulative value and the grade is transmitted to at least one of the plurality of payors, or to a preselected location.

13. The method of claim 7, wherein the authorized service user physical location at authorized service provider is provided by a GPS system physically attached to the encrypted data capture and transmission device.

14. The method of claim 1, wherein the service confirmation center receives payment from individual ones of the plurality of authorized service providers in response to the number of verifications provided to individual ones of the plurality of payors indicating service provision by the authorized service provider.

15. The method of claim 7, wherein the encrypted data capture and transmission device connected in real time to the service confirmation center further comprises a personal computer.

16. The method of claim 15, wherein the personal computer is a laptop computer.

17. The method of claim 16, wherein the laptop computer disables the transmission device in response to one of at least an unauthorized data manipulation and an unauthorized access attempt, and attempts to transmit a system down code to the service center.

18. A method of qualifying medical insurance claims for payment, comprising:
separating incoming claims for service into at least four groups depending upon a number of verification factors selected from the list including proper service provider identification, proper patient identification, specific service provided matched to patient identification, time of service within a selected range, duration of service within selected range for specific service provided, previous time and date of specific service provided to the same patient within selected range, number of previous incidents of specific service provided to the same patient within selected range, location of service provided matched to service provider;
wherein at least some of a plurality of service providers receive a data capture and data transmission device having at least a device location system, a patient identification system, a time measurement system, and a service provider identification system; and
wherein the data capture and data transmission device is a secure system having an encryption code with a key not provided to the service providers or the patient, having an intrusion alert system that transmits an intrusion alarm to a central data reception system and prevents further data entry and data transmission until reset by an encrypted signal from the central data reception system.

19. The method of claim 18, wherein the four groups include an immediate payment group, a group that should have a random sample of claims further examined prior to payment, a group that requires all claims to be further examined prior to payment, and a group that requires resubmission of the claim to correct erroneous inputs.

20. The method of claim 18, wherein patient identification and service provider identification are provided by an encrypted secure system that measures and evaluates at least one of fingerprints, eye scan, facial recognition, biometric data capture, signature capture, voice print capture, PIN entry, smartcard reader, transponder reader, magnetic card reader, physical location of the encrypted system and time of service commencement and time of service completion.
